(19) United States
(12) Patent Application Publication
(10) Pub. No.: US 2011/0066496 A1
(43) Pub. Date: Mar. 17, 2011

(54) Combining Historical CTR and Bid Amount in Search Message Selection

(76) Inventors: Zengyan Zhang, San Jose, CA (US); Jason Zien, Mountain View, CA (US); Sanjav Kshetramade, Fremont, CA (US); Ying Cui, Sunnyvale, CA (US); Song Lin, Sunnyvale, CA (US)

(21) Appl. No.: 12/558,175

(22) Filed: Sep. 11, 2009

(51) Int. Cl. G06Q 10/00; G06F 17/30; G06F 7/10; G06F 15/18

(52) U.S. Cl. 705/14.53; 706/12; 707/E17.109; 705/14.71

(57) ABSTRACT

A method, system and computer readable medium selects additional message content to display to a user when the user request base content. In order to optimize the intermediate selection pool of message candidates (from which a final selection is chosen), for each candidate message, a historical aggregate of CTR data is combined with an offline estimate, also obtained from historical data, of RElative Probability of Action (REPA, which combines computed relevancy scores and ranking information) and with bid amount to obtain an estimate for revenue generation. This estimate is combined with dynamic matching between the message and the page/user pair to obtain a final score for each message that is used to create the intermediate selection pool of message for the page displayed. Final message selection uses a feedback loop, using specific CRT in conjunction with the specific page displayed, for the messages in the intermediately selected pool.

### FIELD OF THE INVENTION

The present invention is directed to a method, apparatus and computer readable medium for selecting messages such as advertisements to serve to a web page, using past performance scores, relevance scores, and message revenue information.

### BACKGROUND OF THE INVENTION

When a user makes a request for base content to a server via a network, additional content is also typically sent to the user along with the base content. The user may be a human user interacting with a user interface of a computer that transmits the request for base content. The user could also be another computer process or system that generates and transmits the request for base content programmatically.

Base content may include a variety of content provided to a user and presented, for example, on a published Web page. For example, base content may include published information, such as articles about politics, business, sports, movies, weather, finance, health, consumer goods, etc. Base content may also include applications (such as iphone app.'s) or pdf files, or any other documents (such as ads being dynamically placed in document files). Additional content may include content that is relevant to the base content or a user. For example, relevant additional content that is relevant to the user may include advertisements for products or services in which the user is likely to have an interest. This type of additional content will be referred to hereinafter as “messages.”

Base content providers receive revenue from advertisers who wish to have their messages, such as advertisements, displayed to users, and who generally pay a particular amount each time a user clicks on one of their messages. This is known as price per click (PPC) model. If this pricing method is used, the revenue received is a function of PPC x Click Through Rate (CTR). Another possible pricing method is price per impression, wherein a charge is levied each time a message is displayed, regardless of click rate. Base content providers employ a variety of methods to determine which additional content to display to a user in order to maximize revenue received. For example, user interest in particular subject categories (i.e., relevance) may be used to determine which additional content to display to the user. Refinements in the selection of message display content are important for the improvement of revenue received.

### SUMMARY OF THE INVENTION

A method and apparatus for selecting additional message content to display to a user when the user request base content is provided. In order to optimize the initial selection pool of message candidates (from which a final selection is chosen), for each candidate message, a historical aggregate of CTR data is combined with an offline estimate, also obtained from historical data, of RElative Probability of Action (REPA, which combines computed relevancy scores and ranking information) and with bid amount to obtain an estimate for revenue generation. This estimate is combined with dynamic matching between the message and the page/user pair to obtain a final score for each message, which is used to create the initial selection pool of messages for the page displayed. Final message selection uses a feedback loop, using specific CRT in conjunction with the specific page displayed, for the messages in the initially selected pool.

### BRIEF DESCRIPTION OF THE DRAWINGS

FIG. 1 is a graph of the weighting of the RCB score according to the number of impressions.

FIG. 2a illustrates one embodiment for the basic quality index data flow.

FIG. 2b is a flow diagram corresponding to FIG. 2a.

FIG. 3 illustrates one embodiment for generating the RCB quality index.

FIG. 4 is an example that shows characteristic graphs of distribution of message scores, i.e., the number of messages vs. their Static Score and Dynamic Score.

FIG. 5 is a high level flow diagram illustrating computation of the Final Score in accordance with one embodiment.

FIG. 6 is a diagrammatic representation of an exemplary computer, system and platform for implementing embodiments of the present invention.

FIG. 7 illustrates one embodiment of a network environment for operation of the message delivery system of the present invention.

### DETAILED DESCRIPTION

When a user makes a request for base content to a base content provider via a network, additional content is also typically sent to the user along with the base content. As used herein, base content connotes content requested by a user. Base content may be presented, for example, as a Web page and may include a variety of content (e.g., news articles, emails, chat-rooms, etc.). Base content may take a variety of forms including text, images, video, audio, animation, program code, data structures, hyperlinks, etc. The base content may be formatted according to the Hypertext Markup Language (HTML), the Extensible Markup Language (XML), Standard Generalized Markup Language (SGML), or any other language.

As used herein, additional content is content sent to the user along with the requested base content. Additional content may include content that is relevant to the base content or a user. Additional content may include, for example, an advertisement or hyperlink (e.g., sponsor link, integrated link, inside link, or the like) in which the user has an interest. Additional content may include a similar variety of content and form as the base content described above.

In some embodiments, a base content provider is a network service provider (e.g., Yahoo! News, Yahoo! Music, Yahoo! Finance, Yahoo! Movies, Yahoo! Sports, etc.) that operates one or more servers that contain base content and receives requests for and transmits base content. A base content provider also sends additional content to users and employs methods for determining additional content to send along with the requested base content, the methods typically being implemented by the one or more servers it operates.

It is clear that displaying the most relevant messages (i.e., additional content) on a Web page results in good user experiences, and also leads to a better message click-through-rate (CTR). However, publishers are most interested in maximizing revenue, which is at least to some extent correlated to positive user experiences. In the standard cost-per-click (CPC) advertising system, advertisers are charged for each click on the message, resulting in revenue of CTR×CPC. Embodiments are disclosed herein to boost CTR as well as CPC, and as a result, boost revenue.

In one embodiment, a score for each message chosen in an initial selection pool is computed. In one embodiment, the score is comprised of two portions: a first portion, referred to herein as the “Static Score”, and a second portion, referred to herein as the “Dynamic Score.” The Static Score is a static property of the message itself. In some embodiments, the Static Score is formulated, for example, from bid amount, message quality measurement, and historical CTR information for the message. The second portion of the score, the Dynamic Score, consists of the dynamic matching between the message and the page/user pair. The total, or “Final Score”, is the weighted average of the Dynamic Score and the Static Score, and may be expressed as:

Final Score=α×Static Score+(1−α)×Dynamic Score,

wherein, α is a user-determined weighting parameter, with a value between 0 and 1.

In some embodiments, the Static Score is determined and normalized for linear combination with the Dynamic Score to generate the Final Score. The Static Score, as defined herein, is a function of the product of the bid amount with a quality index, referred to herein as the Relative Clickability Score (“RCB”). The RCB provides a quantitative comparison between the quality of a specified message with other peer messages. A key aspect of the model is combining two factors into the RCB:
1. Historical aggregated data about the true CTR of the specified message; and
2. An initial estimated CTR based on aggregated historical data about the relevancy score and page ranking of the specified message, normalized over peer messages.

In some embodiments, the RCB model uses a linear combination of the true historical CTR and the estimated CTR (eCTR), with user-determined parameters that define relative weights ascribed to the CTR and eCTR. When there is a large amount of historical data for a specified message, (i.e., there has been ample opportunity for the message to show its performance), the historical true CTR is given more weight. However, when there is limited historical data, (i.e., not enough “impressions”), the estimated CTR is given more weight. The CTR is normalized as a percentile so as to transform it to the same scale as the eCTR: [0,1].

The mathematical description of the construction of the RCB model in accordance with some embodiments is as follows:

RCB=βCTR+(1−β)eCTR

Where: β=f(x)=1/(1+e^{-c}^{₁}^{x})

x=g(impression)=log(impression)−log(c₂)
c₁ and c₂ are two user determined tuning parameters. c₁ describes the coverage, (i.e., how sensitive the weight model is to the number of impressions), and c₂ defines the threshold for determining which score, CTR or eCTR, should be trusted more.

Mathematically, if log(impression)>log(c₂), β>½, so the CTR, or historically derived score, is weighted more heavily, but if log(impression)<log(c₂), β<½, then the eCTR, or estimated score, is weighted more heavily. The tuning parameters are determined by doing a grid search, and are chosen based on the highest accuracy in predicting good messages for the following week.

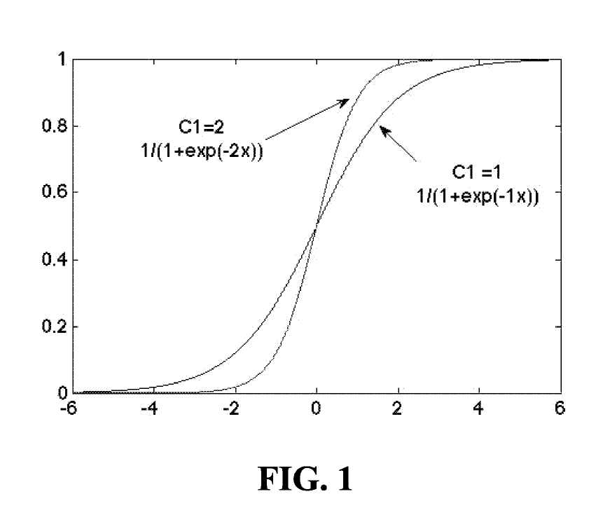

FIG. 1 is a graph of β vs. x for log(c₂)=0, (i.e., β vs. log(impressions), for the embodiment described). As shown in FIG. 1, increasing c₁ sharpens the curve, (i.e., makes the transition from CTR dominated to eCTR dominated more sudden according to the number of impressions).

In one embodiment, CTR is defined as (sum of clicks)/(sum of impressions), aggregated over the preceding 30 day time period. The clicks and impressions in this definition are both validated events (i.e., the clicks and impressions were not derived from fraudulent spamming clicks or automated web crawlers and robots). The basic quality index flow, including the gathering of daily and aggregated statistics, is described below.

eCTR, or estimated CTR, may be calculated based on the relevancy score RS and the rank information (i.e., the positioning or ranking of the message on the display page) of the message in question, compared to all other messages displayed, aggregated over the preceding 30 day time period. The eCTR is used as an initial estimate before there is adequate true historical click through data.

An exemplary mathematical description of the eCTR as incorporated into the RCB formulation described above is:

$${epa}_{ij} ( rank ) = R S / ( 1 + log ( {rank}_{ij} ) ) , \\ r e p {a}_{i} = \frac{{epa}_{ij}}{{\sum }_{i}^{ } {epa}_{ij} / I}$$

$$e C T {R}_{i} = average ( r e p {a}_{i} )$$

### Quality Index Data Flow

An important factor in the above analysis is the collection of historical data. Based on a sensitivity study of the behavior of high quality messages, messages with a high CTR on a certain month tend to maintain it in the following month, then begin to disappear or decay. Thus, in order to estimate the RCB for selection of future messages, the data from the previous month is especially important. Data analysis shows that using the monthly data to predict the following week's top messages is an effective method. The decay speed of good messages tends to be relatively slow. Therefore, a 30-day sliding window database may be used to get the history of a message's performance at the creative level. For this embodiment, the database stores, for each creative/message, information about: click numbers, impressions, rank and relevance. This information is used to estimate and forecast the RCB on a daily basis for each message.

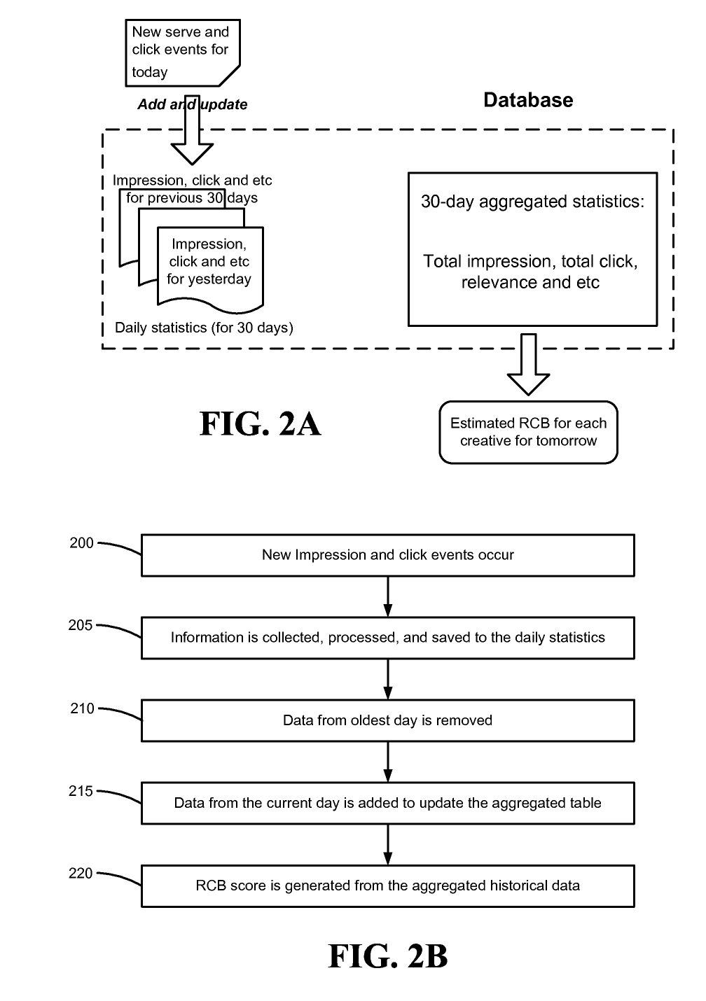

FIG. 2a illustrates one embodiment for an exemplary basic quality index data flow. For this embodiment, the data is divided into two major parts. The first part, which stores the data from each day, identifies the daily statistics for the past 30 days. The second part, which contains the aggregated statistics as a whole, stores the rolling 30-day aggregated statistics. FIG. 2b is a flow diagram corresponding to the data flow of FIG. 2a. Each day, when new impressions and click events occur (200, FIG. 2), the information is collected, processed and saved as the daily statistics (205, FIG. 2). The data from the oldest day is removed (210, FIG. 2), and the data from the current day is added to update the aggregated table (215, FIG. 2). The RCB score is then generated (220. FIG. 2) from the aggregated historical data, as described above.

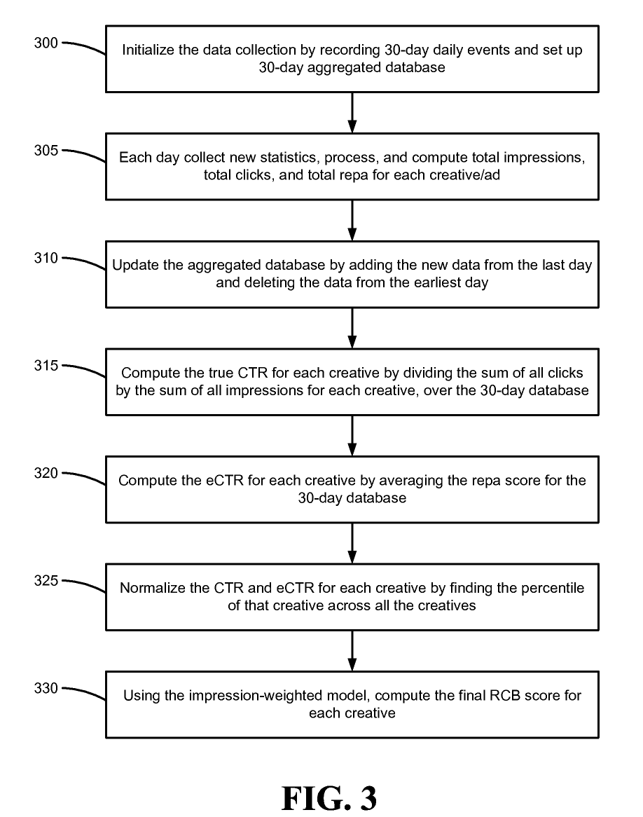

FIG. 3 is a flow diagram that illustrates an exemplary embodiment to generate the RCB quality index. Note that the process is exemplary and other methods may be used without deviating from the spirit or scope of the invention. The data collection is initialized by recording 30-day daily events and setting up a 30-day aggregated database (300, FIG. 3). Each day, collect new statistics, process, and compute total impressions, total clicks, and total REPA for each creative/message (305, FIG. 3). Update the aggregated database by adding the new data from the last day and deleting the data from the earliest day (310, FIG. 3). Then, compute the true CTR for each creative by dividing the sum of all clicks by the sum of all impressions for each creative, over the 30-day database (315, FIG. 3). Compute the eCTR for each creative by averaging the REPA score for the 30-day database (320, FIG. 3). Normalize CTR and eCTR for each creative by finding the percentile of that creative across all the creatives (325, FIG. 3). For this embodiment, the normalized CTR and eCTR fall into the range between 0 and 1. Using the impression-weighted model of equation (1), compute the final RCB score for each creative (330, FIG. 3). In one embodiment, the parameters c₁ and c₂ are trained by grid search and fine-tuned and updated once per month.

The Static Score may be calculated from the RCB, as follows:

Static Score=F(bid, RCB)=1,000,000, if RCB^{s}×bid≧τ, or else 1,000,000×(RCB^{s}×bid)/τ.

The (RCB^{s}×bid) amount is the Estimated Revenue Per Million impression (ERPM) for the message, and “s” is the “squashing factor” that distributes weight between the RCB score and the bid amount (i.e., increasing “s” increases the weight of the RCB score, while a smaller s gives a larger weight to the contribution of the bid amount to the Static Score). τ is a threshold value: above it, the Static Score is given the highest score. Therefore, τ acts as a normalizing factor. The maximum value is chosen so that the Static Score follows a similar value distribution as the Dynamic Score.

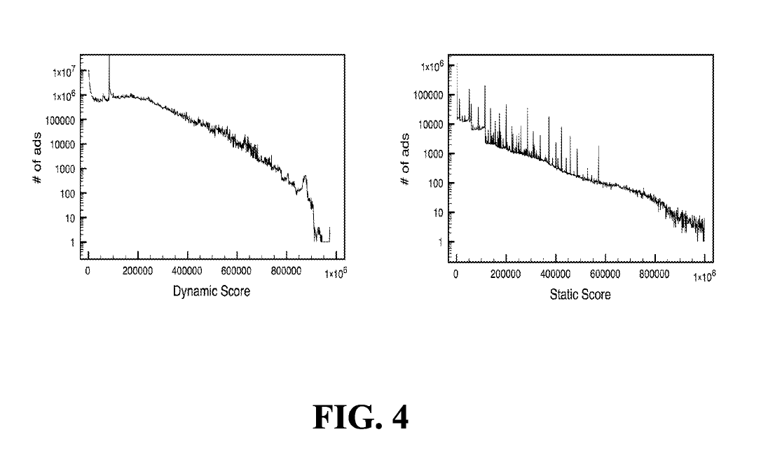

FIG. 4 shows exemplary graphs of distributions for message scores, (i.e., the number of messages vs. their Static Score and Dynamic Score). Both scores range from 0 to 1,000,000, and follow a similar data distribution.

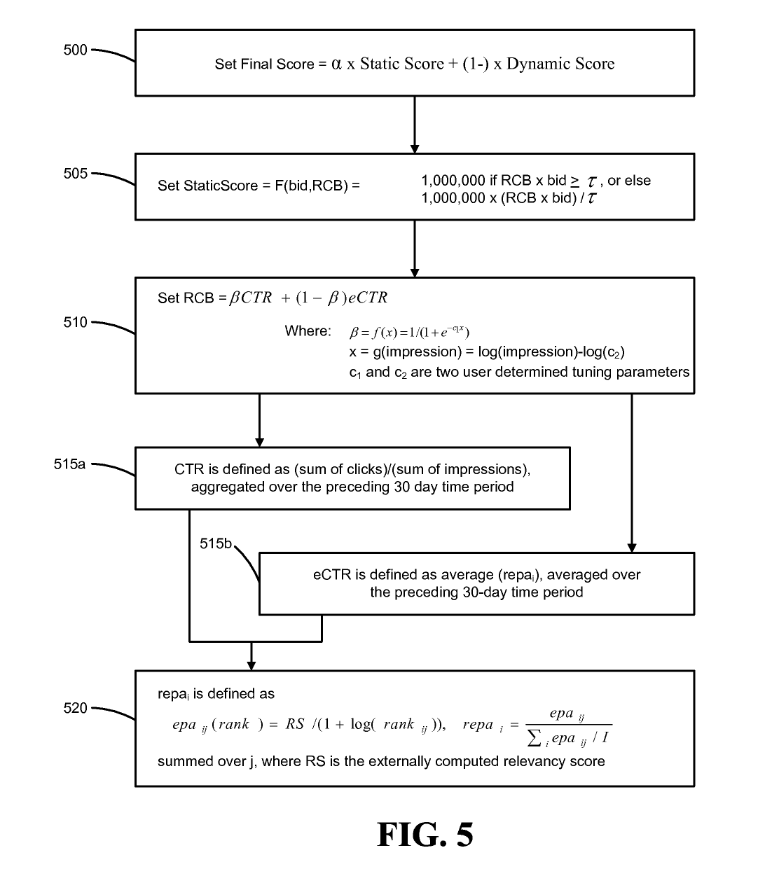

FIG. 5 is a high level flow diagram illustrating computation of the Final Score according to one embodiment.

Initially, Final Score is set equal to:

Final Score=α×Static Score+(1−α)×Dynamic Score, (500, FIG. 5). Then, Static Score is computed (505, FIG. 5) by:

Static Score=F(bid, RCB)=1,000,000, if RCB^{s}×bid≧τ. or else

1,000,000×(RCB^{s}×bid)/τSet RCB=βCTR+1−β,)eCTR (510, FIG. 5)

wherein: β=f(x)=1/(1+e^{-c}^{₁}^{x})

x=g(impression)=log(impression)−log(c₂)
c₁ and c₂ are two user determined tuning parameters CTR is defined as (sum of clicks)/(sum of impressions), aggregated over the preceding 30 day time period (515A, FIG. 5). Then, eCTR is defined as average(repaᵢ), averaged over the preceding 30 day time period (515B, FIG. 5). Specifically, repaᵢ is defined (520, FIG. 5) as

$${epa}_{ij} ( rank ) = R S / ( 1 + log ( {rank}_{ij} ) ) , \\ r e p {a}_{i} = \frac{{epa}_{ij}}{{\sum }_{i}^{ } {epa}_{ij} / I}$$

summed over j, where RS is the externally computed relevancy score.

### Implementation

Due to the huge amount of data processing required to implement the RCB and ERBM generation model disclosed herein, in some embodiments, the model is implemented using grid computing. In general, grid computing is described in Hadoop: The Definitive Guide, 1^{st} Edition, O'Reilly Media, 2009. Described hereinafter is an exemplary computer implemented method. Note that the method is exemplary and other methods may be used without deviating from the spirit or scope of the invention.

Using grid computing, the majority of both the RCB and ERPM calculation is conducted offline. In one embodiment, the 30-day aggregated database and daily statistics are obtained by map-reduce jobs, described in “MapReduce: Simplified Data Processing on Large Clusters”, by Jeffrey Dean and Sanjay Ghemawat, usenix.org. Specifically, Hadoop streaming and Pig jobs (See “Pig Latin: A Not-So-Foreign Language for Data Processing”, Christopher Olston, Benjamin Reed, Utkarsh Srivastava, Ravi Kumar and Andrew Tomkins, Proceedings of the 2008 ACM SIGMOD International Conference on Management of Data, Vancouver, Canada, 2008) may be implemented using 60 nodes for about 1 hour daily to generate the data. The offline jobs are triggered by the daily serve and click events, and run automatically under a scheduler such as the Yawn scheduler (e.g., Yahoo's internal grid computing scheduler). Once the RCB score computation is completed, it is joined with a database that stores the message inventory, to obtain the bid information for each creative. The bid value and RCB score are combined to get the ERPM score for each creative. If the bid values are not available for some creatives, the ERPM values for those creatives are set, as a default, to the median value of the other ERPM's, in order to give those creatives some chance to be shown in the future.

The model parameters in this exemplary embodiment are updated once a month. The model is trained, for example, the first day of each month, and the configuration file is modified to plug in the new optimal parameters obtained. The training objective is to find the best c₁ and c₂ with the highest recall for good messages, using the grid search with exponential steps. The optimal parameters may be used in the model for the following month. In one example, c₁ was searched from 1e-4 to 1e5 in exponential steps, and c₂ was searched from 1 to 1e5. For this example, c1=0.5 and c2=400 yield the highest accuracy in forecasting good messages (i.e., with an accuracy of 93.46%).

Once the ERPM score for each creative message is computed, it is used as one attribute of the message in the index, and the index is pushed to all the serving nodes. In the online evaluation time, the ERPM score is linearly combined with dynamic scores computed with different relevance models, to generate the final evaluation score of each message. Only the messages with the highest final scores are selected as candidate messages (i.e., messages selected for delivery). In some embodiments, final message selection uses a feedback loop, using specific CRT in conjunction with the specific page displayed, for the messages in the initially selected pool of candidate messages.

Table 1 shows exemplary evaluation data comparing different weightings of the Static Score.

TABLE 1
ncdg test results for EPRM scores

| Bucket Id | RISe Config | Ndcg-3 | coverage | Difference |
|---|---|---|---|---|
| B0 | Baseline bucket, ssw = 0.13 | 1.2553 | 26.30% | |
| B1 | B0 + ssw = 0 | 1.2395 | 26.70% | 38.26% |
| B10 | erpmV1, ssw = 0.05 | 1.2135 | 26.60% | 47.31% |
| B11 | erpmV1, ssw = 0.1 | 1.2293 | 26.70% | 56.23% |
| B12 | eprmV1, ssw = 0.15 | 1.2523 | 26.30% | 55.48% |
| B13 | erpmV1, ssw = 0.2 | 1.2688 | 24.30% | 44.72% |
| B14 | erpmV1, ssw = 0.25 | 1.277 | 20.20% | 34.62% |

The data is divided into different testing buckets, shown in column 1. Column 2 displays the server configuration, where Static Score Weight (ssw) α is varied (i.e., varying how much relative weight is given to the dynamic score verse the static score calculated using the one-month aggregated history model). Baseline bucket B0 uses the bid amount of the message as the Static Score, and uses an ssw of 0.13. Subsequent buckets use the RCB×bid to obtain the static score, and the ssw varies between 0 and 0.25. Column 3 displays the Normalized Discounted Cumulative gain (Ndcg-3) results, a measure of effectiveness of a Web search engine algorithm or related applications, often used in information retrieval. In this case, it measures the relevance of the selected message group. Column 4 lists test coverage, and column 5 lists the difference in the message selection results between the bucket in question and baseline bucket B0.

As shown in Table 1, the ERPM score method disclosed herein yields similar relevance measurements to the baseline method, but the message candidate selection is considerably different, up to 56%. This indicates that use of the ERPM methods provides potential for improvement of the CTR, PPC and revenue.

One set of experimental bucket test results shows that the ERPM based static scoring technique generates 4.61% CTR gain, 9.63% PPC gain and 14.72% RPM gain (revenue per thousand impression). Thus, experimental results indicate substantial improvement in click through rate and revenue generation when the message selection model outlined herein is used.

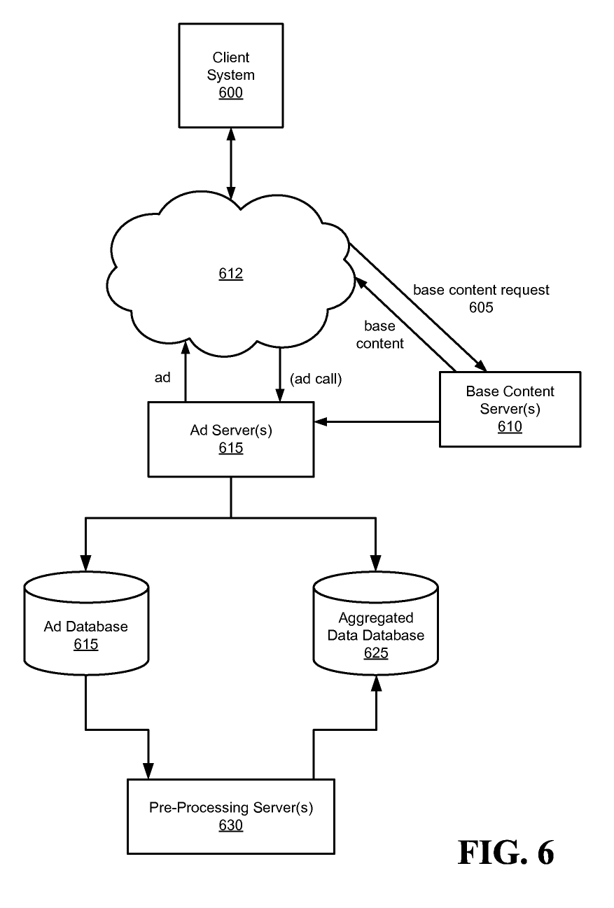

FIG. 6 is a block diagram that illustrates an exemplary system for implementing an optimized message delivery system. Client system 600 (also termed “user”) presents base content request 605 to base content server 610 via network infrastructure 612, which may be the Internet. Additional content server(s) (which will be referred to interchangeably as “message servers”) 615 determines the additional message content to be presented or displayed along with the base content. Message server(s) 615 has access to message database 620, and to aggregated data database 625. Pre-processing server(s) 630, which may comprise grid computing nodes, process data incorporated into database 625.

### System Considerations

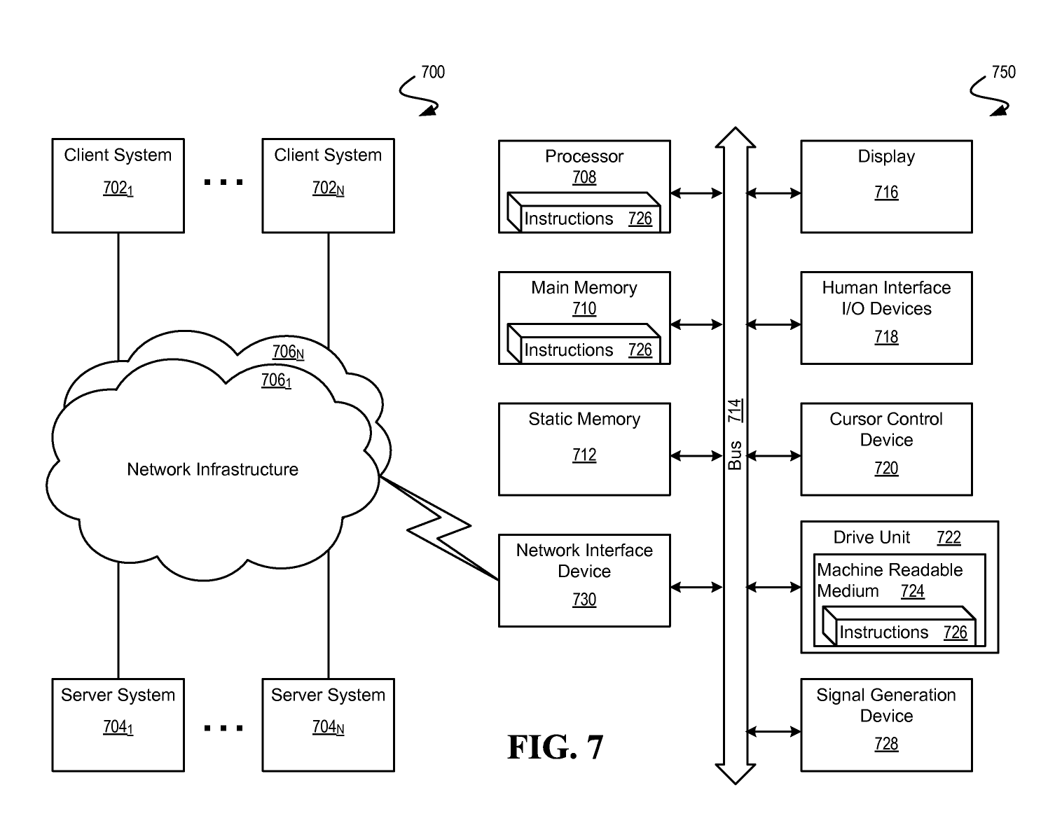

FIG. 7 illustrates one embodiment of a network environment 700 for operation of the message delivery system of the present invention. As shown in FIG. 7, a diagrammatic representation of a network 700 includes nodes for client computer systems 702₁ through 702_{N}, nodes for server computer systems 704₁ through 704_{N}, nodes for network infrastructure 706₁ through 706_{N}, any of which nodes may comprise a machine within which a set of instructions for causing the machine to perform any one of the techniques discussed above may be executed. The embodiment shown is purely exemplary, and might be implemented in the context of one or more of the figures herein.

Any node of the network 700 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g. a combination of a DSP and a microprocessor, a plurality of microprocessors, one or more microprocessors in conjunction with a DSP core, or any other such configuration, etc).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g. a client computer system, a server computer system) and/or may comprise one or more embedded computer systems, a massively parallel computer system, and/or a cloud computer system.

The computer system 750 includes a processor 708 (e.g. a processor core, a microprocessor, a computing device, etc), a main memory 710 and a static memory 712, which communicate with each other via a bus 714. The machine 750 may further include a display unit 716 that may comprise a touch-screen, or a liquid crystal display (LCD), or a light emitting diode (LED) display, or a cathode ray tube (CRT). As shown, the computer system 750 also includes a human input/output (I/O) device 718 (e.g. a keyboard, an alphanumeric keypad, etc), a pointing device 720 (e.g. a mouse, a touch screen, etc), a drive unit 722 (e.g. a disk drive unit, a CD/DVD drive, a tangible computer readable removable media drive, an SSD storage device, etc), a signal generation device 728 (e.g. a speaker, an audio output, etc), and a network interface device 730 (e.g. an Ethernet interface, a wired network interface, a wireless network interface, a propagated signal interface, etc).

The drive unit 722 includes a machine-readable medium 724 on which is stored a set of instructions (i.e. software, firmware, middleware, etc) 726 embodying any one, or all, of the methodologies described above. The set of instructions 726 is also shown to reside, completely or at least partially, within the main memory 710 and/or within the processor 708. The set of instructions 726 may further be transmitted or received via the network interface device 730 over the network bus 714.

It is to be understood that embodiments of this invention may be used as, or to support, a set of instructions executed upon some form of processing core (such as the CPU of a computer) or otherwise implemented or realized upon or within a machine- or computer-readable medium. A machine-readable medium includes any mechanism for storing or transmitting information in a form readable by a machine (e.g. a computer). For example, a machine-readable medium includes read-only memory (ROM); random access memory (RAM); magnetic disk storage media; optical storage media; flash memory devices; electrical, optical, acoustical or other form of propagated signals (e.g. carrier waves, infrared signals, digital signals, etc); or any other type of media suitable for storing or transmitting information.

While the invention has been described with reference to numerous specific details, it is not intended that the invention be limited to the exact embodiments disclosed herein. It should be clear to one skilled in the art that changes and modifications may be made without departing from the inventive concept. The scope of the invention should be construed in view of the claims.

What is claimed is:

1. A method for selecting additional message content to display to a user when a user request for base content is provided, said user and said base content forming a page/user pair, the method comprising:
storing, in memory, a plurality of messages as a set of initial candidate messages;
storing, in memory, an offline estimate of message performance for each of said initial candidate messages based on estimated message quality measured relative to messages from a peer group of messages;
storing, in memory, historical data of message performance for each of said initial candidate messages;
processing said user request by forming a set of intermediate candidate messages for use in final message selection by generating a ranking based on said historical data of message performance, said offline estimate of message performance and a relevance match between said initial candidate message and said page/user pair; and
forming said set of intermediate candidate messages from said set of initial candidate messages based on said ranking.

2. The method of claim 1, wherein processing said user request by forming a set of intermediate candidate messages comprises:
generating a static score for each of said initial candidate messages by combining said historical data of message performance with said offline estimate of message performance;
generating a dynamic score for each of said initial candidate messages that reflects said relevance match between said initial candidate message and said page/user pair; and
combining said static score with said dynamic score to obtain a final score for each of said initial candidate messages, said final score being a measure of the expected performance of said initial candidate message if displayed to said page/user pair.

3. The method of claim 2, wherein generating a static score for each of said initial candidate messages by combining said historical data of message performance with said offline estimate of message performance comprises combining historical click through rate with historical relevance data, historical ranking data, and bid amount for each said candidate message to form said static score for each said candidate message.

4. The method of claim 3, wherein combining historical click through rate with historical relevance data, historical ranking data, and bid amount for each said candidate message to form said first static score for each said candidate message comprises:
forming a historical aggregate of Click Through Rate (CTR) data from impressions of said candidate message to form a CTR score for said candidate message;
combining said CTR score with an offline historical aggregate estimate of Relative Probability of Action (REPA) to form an RCB score, said REPA combining computed relevancy scores and ranking information; and
combining said RCB score with a bid amount for said candidate message to form said static score.

5. The method of claim 4, wherein combining said CTR score with an offline historical aggregate estimate comprises forming a first weighted linear combination of said CTR score and said REPA, said first weighted linear combination incorporating a first weighting parameter dependent on the number of said impressions.

6. The method of claim 5, wherein said first weighting parameter is further dependent on a first and a second tuning parameter that is user-determined and trained to optimize accuracy of message forecasting.

7. The method of claim 5, wherein a larger number of said impressions results in a higher weight for said CTR score relative to said REPA in said first weighted linear combination.

8. A system for selecting additional message content to display to a user when a user request for base content is provided, said user and said base content forming a page/user pair, the system comprising:
memory for storing a plurality of messages as a set of initial candidate messages, for storing an offline estimate of message performance for each of said initial candidate messages based on estimated message quality measured relative to messages from a peer group of messages, and for storing historical data of message performance for each of said initial candidate messages; and
at least one processor, coupled to said memory, for processing said user request by forming a set of intermediate candidate messages for use in final message selection by generating a ranking based on said historical data of message performance, said offline estimate of message performance and a relevance match between said initial candidate message and said page/user pair, and for forming said set of intermediate candidate messages from said set of initial candidate messages based on said ranking.

9. The system of claim 8, wherein said at least one processor further for:
generating a static score for each of said initial candidate messages by combining said historical data of message performance with said offline estimate of message performance;
generating a dynamic score for each of said initial candidate messages that reflects said relevance match between said initial candidate message and said page/user pair; and
combining said static score with said dynamic score to obtain a final score for each of said initial candidate messages, said final score being a measure of the expected performance of said initial candidate message if displayed to said page/user pair.

10. The system of claim 9, wherein said at least one processor further for:
combining historical click through rate with historical relevance data, historical ranking data, and bid amount for each said candidate message to form said static score for each said candidate message.

11. The system of claim 10, wherein said at least one processor further for:
forming a historical aggregate of Click Through Rate (CTR) data from impressions of said candidate message to form a CTR score for said candidate message;
combining said CTR score with an offline historical aggregate estimate of Relative Probability of Action (REPA) to form an RCB score, said REPA combining computed relevancy scores and ranking information; and
combining said RCB score with a bid amount for said candidate message to form said static score.

12. The system of claim 11, wherein said at least one processor further for:
forming a first weighted linear combination of said CTR score and said REPA, said first weighted linear combination incorporating a first weighting parameter dependent on the number of said impressions.

13. The system of claim 12, wherein said first weighting parameter is further dependent on a first and a second tuning parameter that is user-determined and trained to optimize accuracy of message forecasting.

14. A computer readable medium that stores instructions, which when executed by a processor, causes the processor to select additional message content to display to a user when a user request for base content is provided, said user and said base content forming a page/user pair, said instructions for:
storing a plurality of messages as a set of initial candidate messages;
storing an offline estimate of message performance for each of said initial candidate messages based on estimated message quality measured relative to messages from a peer group of messages;
storing historical data of message performance for each of said initial candidate messages;
in response to said user request, forming a set of intermediate candidate messages for use in final message selection by generating a ranking based on said historical data of message performance, said offline estimate of message performance and a relevance match between said initial candidate message and said page/user pair; and
forming said set of intermediate candidate messages from said set of initial candidate messages based on said ranking.

15. The computer readable medium of claim 14, wherein instructions for processing said user request by forming a set of intermediate candidate messages comprises instructions for:
generating a static score for each of said initial candidate messages by combining said historical data of message performance with said offline estimate of message performance;
generating a dynamic score for each of said initial candidate messages that reflects said relevance match between said initial candidate message and said page/user pair; and
combining said static score with said dynamic score to obtain a final score for each of said initial candidate messages, said final score being a measure of the expected performance of said initial candidate message if displayed to said page/user pair.

16. The computer readable medium of claim 15, wherein instructions for generating a static score for each of said initial candidate messages by combining said historical data of message performance with said offline estimate of message performance comprises instructions for combining historical click through rate with historical relevance data, historical ranking data, and bid amount for each said candidate message to form said static score for each said candidate message.

17. The computer readable medium of claim 16, wherein instructions for combining historical click through rate with historical relevance data, historical ranking data, and bid amount for each said candidate message to form said first static score for each said candidate message comprises instructions for:
forming a historical aggregate of Click Through Rate (CTR) data from impressions of said candidate message to form a CTR score for said candidate message;
combining said CTR score with an offline historical aggregate estimate of Relative Probability of Action (REPA) to form an RCB score, said REPA combining computed relevancy scores and ranking information; and
combining said RCB score with a bid amount for said candidate message to form said static score.

18. The computer readable medium of claim 17, wherein instructions for combining said CTR score with an offline historical aggregate estimate comprises instructions for forming a first weighted linear combination of said CTR score and said REPA, said first weighted linear combination incorporating a first weighting parameter dependent on the number of said impressions.

19. The computer readable medium of claim 18, wherein instructions for said first weighting parameter is further dependent on a first and a second tuning parameter that is user-determined and trained to optimize accuracy of message forecasting.

20. The computer readable medium of claim 18, wherein a larger number of said impressions results in a higher weight for said CTR score relative to said REPA in said first weighted linear combination.
